(19) United States
(12) Patent Application Publication
(10) Pub. No.: US 2014/0131140 A1
(43) Pub. Date: May 15, 2014

(54) PNEUMATIC PISTON ELEVATOR

(71) Applicant: Reinaldo Verde, Miami, FL (US)

(72) Inventor: Reinaldo Verde, Miami, FL (US)

(21) Appl. No.: 13/673,996

(22) Filed: Nov. 10, 2012

(51) Int. Cl. B66B 9/04

(52) U.S. Cl. CPC B66B 9/04
USPC 187/247; 187/250; 187/273; 92/62

(57) ABSTRACT

In accordance with one embodiment, an elevator assembly for placing an elevator within a structure is provided. The elevator assembly may include elevator housing, such that the elevator housing may have a metal frame to secure a movable elevator cab. The metal frame may be formed using at least one of steel or aluminum or a combination thereof or the like. The metal frame may be reinforced material such that the metal frame is a self-supporting structure.

### BACKGROUND OF THE INVENTION

1. Field of the Invention

Embodiments of the present invention generally relate to elevators, and more particularly to pneumatic piston elevators.

2. Description of the Related Art

An elevator is used to hoist persons, animals or things, vertically. The vertical transport device or apparatus know to date present numerous disadvantages. Such disadvantages range from high economic costs to the consumers of placing the vertical transport device, a high environmental costs, and efficiency of the vertical transport device or apparatus.

Various constructive and functional variations of this type of devices are known; noteworthy among them are those in which the vertical movement of the cab, or moving vehicle, uses cables which twist around a drum or pulley, operated by a motor, usually electrical; as well as those employed for the same purpose, using vertical racks engaging the teeth of gears operated by a motor, generally located above or below the cab, requiring shorter cables since, if cables are used, they are used only for counterweights.

Furthermore, the residential elevators have smaller cross-sectional area within which the elevator may operate. Therefore, space required to accommodate the elevator is additional constrain when designing elevators.

Therefore, a need exists for elevators designed to allow builders of smaller structures place economic elevators that are environmentally friendly in the structures.

### SUMMARY

In accordance with one embodiment, an elevator assembly for placing an elevator within a structure is provided. The elevator assembly may include elevator housing, such that the elevator housing may have a metal frame to secure a movable elevator cab. The metal frame may be formed using at least one of steel or aluminum or a combination thereof or the like. The metal frame may be reinforced material such that the metal frame is a self-supporting structure.

The elevator housing of the elevator assembly may include at least one of plastic, glass or wood panels or any combination thereof. In an exemplary embodiment, the cab ceiling may have perforations. The elevator in one embodiment may have a swing door allowing at least a 180 degree door opening angle. The elevator may have one or more LED lights and/or one or more fans that may be configurable. The lights and fans may be configured to turn on or off. For example, as a user may enter the elevator a plurality of light emitting diode (LED) lights and/or a plurality of fans may automatically turn on.

Furthermore, the elevator housing may have a plurality of guides for directing the elevator cab within the housing. The guide may be formed within the metal frame for allowing cab to move within the housing. For example, the plurality of guides for directing the elevator cab is one of a roller guide, a slide guide, or a rail guide or any combination thereof. The elevator assembly may have up to four guides within the elevator frame.

In one embodiment, the elevator assembly may have at least one pneumatic piston capable of causing ascent by using only air pressure. In one embodiment, the elevator assembly may have at least one pneumatic piston capable of causing ascent by using only air pressure. For example, the piston may be a single-acting air cylinders with gravity retraction.

The elevator assembly with pistons allows the assembly to do away with a pit, a hoistway, or a machine room. For example, the pneumatic may be piston placed between the longitudinal side of the elevator cab and the metal frame of the elevator housing. For example, the pneumatic piston is placed at the corner edges of the elevator car.

In one embodiment, the elevator assembly disclosed herein is suitable for elevation of up to three floors. The pneumatic piston used may be a pneumatic telescopic piston assembly. The pneumatic telescopic piston assembly may have housing with an internal chamber extending longitudinally within the housing. The housing may be a square or a cylindrical. The housing may further house one or more concentric inner cylinders. The plurality of concentric cylinders may be arranged such that the housing and the plurality of inner cylinders are hermetically sealed. Each of the inner cylinder/s provides a stage of the pneumatic telescopic piston with each of the concentric cylinders collapsible so as to fit within the length of the telescopic piston. For example, the pneumatic telescopic piston may have up to three collapsible stages.

In one embodiment of the subject matter disclosed herein the piston housing may be connected to a compressed air source. Once inflated, the pneumatic telescopic piston may be deflated by allowing the air to escape via valves. For example, the housing and the plurality of inner cylinders may have a plurality of valves enabling air to inflate or deflate the telescopic piston.

The pneumatic telescopic piston may be configured to have a base width between four to six inches and a top cylinder having a width between two to three inches. In one embodiment of the subject matter disclosed herein the pneumatic piston/s used in the elevator assembly may be composed of hard anodized aluminum alloy. Furthermore, the pneumatic piston/s may use a high impact low friction metal pistons and rubber bearings. Alternatively, the pneumatic piston may be pre-lubricated for use with a dry air compressor. The dry air compressor may at least one hundred fifty pounds per square inch pressure.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a front view of an elevator in accordance with an embodiment.

FIG. 2 illustrates the elevator assembly in accordance with an embodiment.

FIG. 3 illustrates the top view of the elevator assembly in accordance with an embodiment.

FIG. 4 illustrates the bottom view of the elevator assembly in accordance with an embodiment.

FIG. 5 illustrates the sectional view of an elevator cab in accordance with an embodiment.

FIG. 6 illustrates a pneumatic telescopic piston in accordance with an embodiment.

FIG. 7 illustrates the sectional view of the pneumatic telescopic piston in accordance with an embodiment.

FIG. 8 illustrates an alternate embodiment of elevator cab and pneumatic piston in accordance with an embodiment.

FIG. 9 illustrates an alternate embodiment of elevator cab and pneumatic piston in accordance with an embodiment.

FIG. 10 illustrates an alternate embodiment of elevator cab and pneumatic piston in accordance with an embodiment.

FIG. 11 illustrates an alternate embodiment of elevator cab and pneumatic piston in accordance with an embodiment.

FIG. 12 illustrates an alternate embodiment of elevator cab and pneumatic piston in accordance with an embodiment.

FIG. 13 illustrates an alternate embodiment of elevator cab and pneumatic piston in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

FIG. 1 illustrates a front view of an elevator assembly 100 in accordance with an embodiment. The subject matter disclosed herein covers an elevator assembly of the specified type, pertaining to the category of those made up of a combination of vertical shaft (elevator housing 100) and moving transport vehicle (elevator cab 104) located inside the elevator housing 100, connected to devices capable of causing ascent and descent between the upper end 106 and lower end 108. The upper end 106 and lower end 108 may have optional intermediary stops including the corresponding doors 110. The optional intermediary stops allow for transfer between the vehicle and the various floors. The elevator assembly being equipped with operation and safety means, as well as means to keep such vehicle braked while stopped at the level of an open door.

Additionally, the present invention is directed to pneumatic piston elevators that are to be used in structures that are up to three floors. The pneumatic piston elevator may be telescopic powered by air pressure. The invention was designed to allow builders of smaller structures place economic elevators that are environmentally friendly in the structures. The elevators do not require hydraulic fluids or any other type of lubricant, for they use air pressure to lift the elevators. In addition the elevator may require minimal lubricant for mechanical parts. The elevator may use a plurality of air compressor. The air compressor may be noise free and may be able to generate at least 150 PSI. The compressor may be located at the bottom, on the side or at the top of the elevator housing. The average cost to place the elevator assembly 100 in a structure may cost between eight thousand dollars to twenty thousand dollars. The cost of the elevator may vary based of a plurality of factors. For example, the factors may be the capacity of the elevator for up to three simultaneous users, or wheelchair enabled elevator, or an elevator allowing attendant to manage the elevator.

The elevator assembly 100 is an economical alternative to contemporary elevators that can be place within existing structures without a need for pits, hoistway, machine rooms, or prefabricated supports. Moreover, the elevator assembly 100 provides is easily installable as a metal frame houses the pneumatic telescoping pistons and the elevator may be install within a structure that requires cutting a whole within a floor in which the elevator will open or it can be placed adjacent to a mezzanine floor.

In accordance with one embodiment, an elevator assembly for placing an elevator within a structure is provided. The elevator assembly may include elevator housing, such that the elevator housing may have a metal frame to secure a movable elevator cab. The metal frame may be formed using at least one of steel or aluminum or a combination thereof or the like. The metal frame may be reinforced material such that the metal frame is a self-supporting structure.

The elevator housing of the elevator assembly may include at least one of plastic, glass or wood panels or any combination thereof. In an exemplary embodiment, the cab ceiling may have perforations. The elevator may have one or more LED lights and/or one or more fans that may be configurable. The lights and fans may be configured to turn on or off. For example, as a user may enter the elevator a plurality of light emitting diode (LED) lights and/or a plurality of fans may automatically turn on.

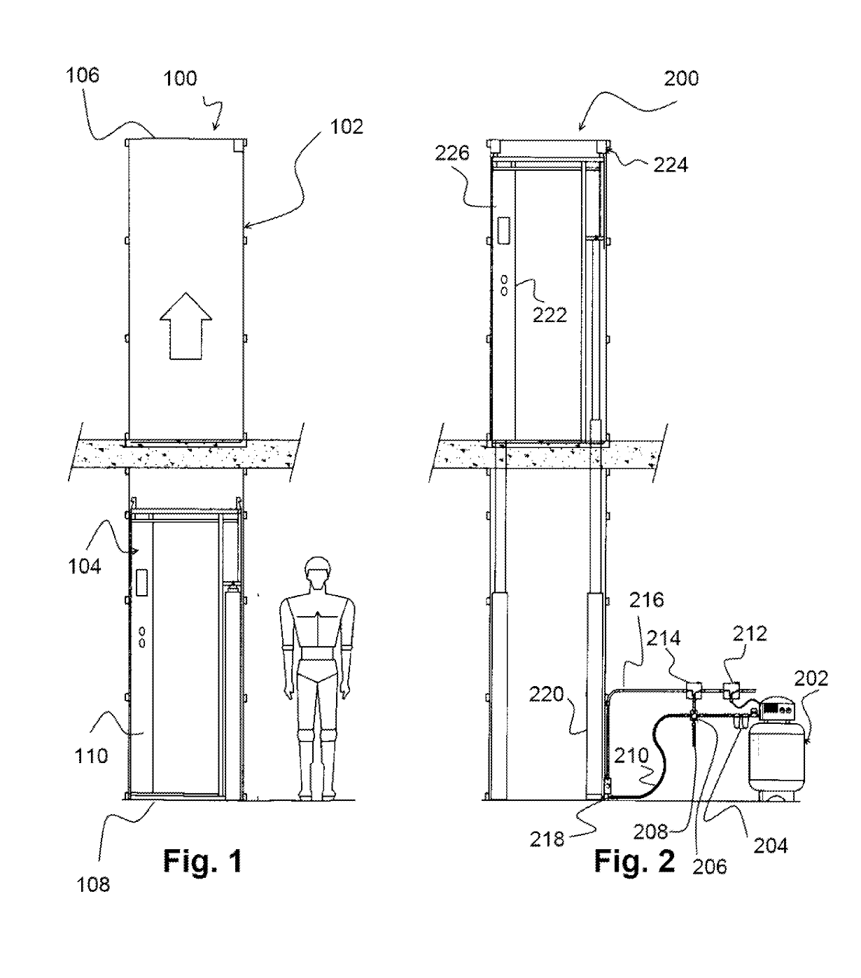

FIG. 2 illustrates the elevator assembly 200 in accordance with an embodiment. The elevator assembly 200 may use a power dry air compressor 202 that is used to provide compressed air at about 150 pound per square inches. The compressor may be connected to an air filter 204 to help remove solid particulates such as dust, pollen, mold, and bacteria from the air. The air filter may be composed of fibrous materials and/or chemical absorbents or catalysts.

A control module 206 providing controlling/operating signals for the elevator assembly 200 operations. In one embodiment, the control module 206 may be a pneumatic electronic control module for controlling single air cylinder with gravity retraction. When the elevator assembly includes a plurality of pneumatic telescopic piston, the control module 206 may allow controlling independent extensions and retraction speed of cylinders of the telescopic piston. In one embodiment of the subject matter disclosed herein the piston housing may be connected to a compressed air source. Once inflated, the pneumatic telescopic piston may be deflated by allowing the air to escape via valves. For example, the housing and the plurality of inner cylinders may have a plurality of valves enabling air to inflate or deflate the telescopic piston.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (CPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

The exhaust air within the pneumatic pistons may be carried within the air outlet hose 208. The control module 206 controls the air from the pistons via the in/out air hose 210. A user interface control panel 222 may be provided within the elevator cab 226. The in-out air hose 210 carries the air to the outlet hose 208 from where the air is exhausted to allow deflation. The compressor 202 may be connected to the pneumatic telescopic piston 220 using an air connector 218. The elevator cab 226 may be held in an intermediary level by a plurality of mechanical safety locks 224.

The air compressor 202 receives electrical input from a first electrical box 212. The first electrical box 212, in one embodiment, may provide up to 120v power supply. The first electrical box 212 may have additional circuitry to prevent electrical damage to the air compressor 202. The elevator assembly 200 may have a second electrical box 214 to provide operational power to the control module 206. For example, the first electrical box 212 and the second electrical box 214 may receive power from the same electrical line 216.

In one embodiment, the elevator assembly disclosed herein is suitable for elevation of up to three floors. The pneumatic piston used may be a pneumatic telescopic piston assembly. The pneumatic telescopic piston assembly may have housing with an internal chamber extending longitudinally within the housing. The housing may be a square or a cylindrical. The housing may further house one or more concentric inner cylinders. The plurality of concentric cylinders may be arranged such that the housing and the plurality of inner cylinders are hermetically sealed. Each of the inner cylinder/s provides a stage of the pneumatic telescopic piston with each of the concentric cylinders collapsible so as to fit within the length of the telescopic piston. For example, the pneumatic telescopic piston may have up to three collapsible stages.

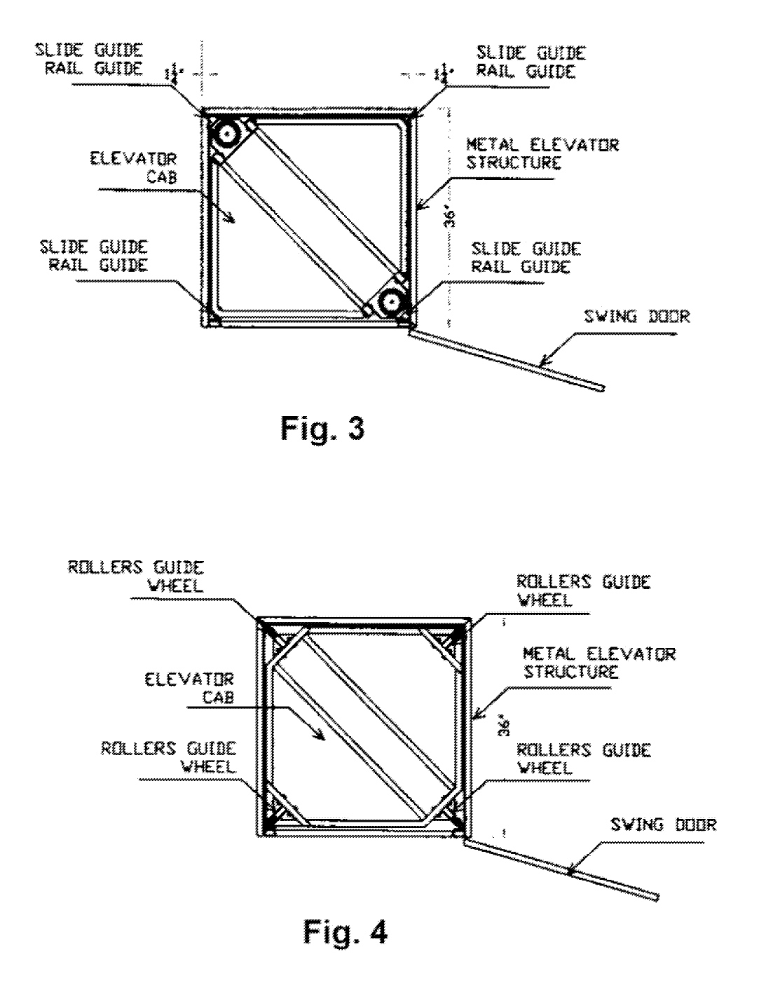

FIG. 3 illustrates the top view of the elevator assembly 300 in accordance with an embodiment. FIG. 4 illustrates the bottom view of the elevator assembly in accordance with an embodiment. The elevator assembly 300 shows an elevator with two pneumatic telescopic pistons located at two corners, in accordance with an embodiment. The elevator assembly 300 does not require any pit excavation, or hoist way, or machine room. The elevator assembly may be installed within two days making it ideal for new or existing homes. Additionally, a minimal space is required to accommodate the elevator. The elevator is safe to use in case of a power failure since the moving car automatically descends to the lowest level and the electro-mechanical door will open to let the passenger out. The self-supporting structure allows the elevator to rest on any existing floor.

The elevator described herein is an eco-friendly elevator as the descent is based on the gravitational retraction of the piston thereby no operational power is required during elevator descent. Also, since the retraction is gravitational, the starting and stopping operations are extremely smooth. The panel of the elevator may be fully transparent providing panoramic view without cables or pistons that block the vision. The electric circuits within the cabin may be 24 volts, thus eliminating the risk of severe shock.

The elevator requires minimal maintenance. The maintenance required on the elevator described may be done every five years or 15,000 lifts for replacement of main seal. The elevator may travel at a speed of about 30 feet per minute. The total weight of a 9 feet high elevator with a capacity for two simultaneous users may be about 700 pounds. Alternatively, elevator with 9 foot ceiling and two stops may weigh about 800 pounds. The elevator may be shipped in a disassembled state for ease of handling and transportation. The box containing disassembled elevator may fit through a door 36″ wide and 80″ high.

The elevator in one embodiment may have a swing door allowing at least a 180 degree door opening angle. Furthermore, the elevator housing may have a plurality of guides for directing the elevator cab within the housing. The guide may be formed within the metal frame for allowing cab to move within the housing. For example, the plurality of guides for directing the elevator cab is one of a roller guide, a slide guide, or a rail guide or any combination thereof. The elevator assembly may have up to four guides within the elevator frame.

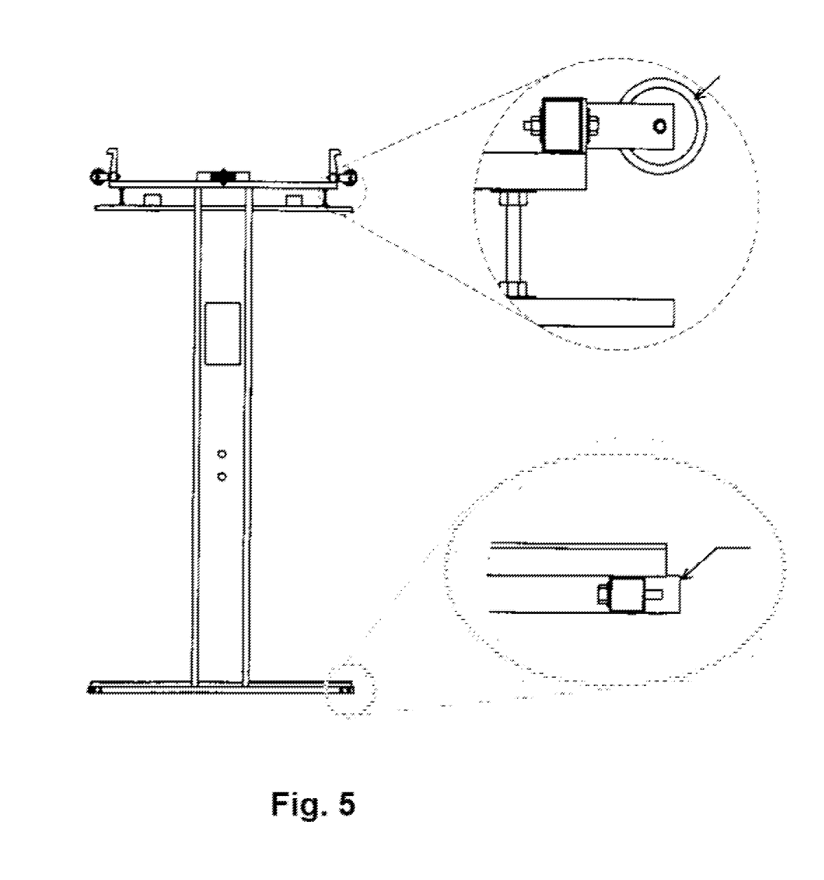

As shown in FIG. 3, the elevator may have slide guide rails towards the top side of the elevator cab for guiding the elevator cab's top edge. Similarly, the elevator cab may have roller guide wheel at the bottom side for guiding the bottom of the elevator cab, as shown in FIG. 4. FIG. 5 illustrates the sectional view of an elevator cab in accordance with an embodiment. The elevator cab as shown in FIG. 5 illustrates an alternate embodiment of a guide mechanism. The elevator cab may have the roller guide wheel at the top edge and slide guide at the lower edge.

FIG. 6 illustrates a pneumatic telescopic piston in accordance with an embodiment. As used herein, the term telescopic piston and telescopic cylinder are interchangeable. The present invention has provided a telescopic cylinder comprised of an outer cylinder, a plurality of decreasing diameter pistons/cylinders. The pneumatic piston has an open end, a closed end and at least one passage, transversely disposed in the housing through the cylinder wall, to enable compressed air to inflate the piston cylinders. The plurality of decreasing diameter piston/cylinders is successively concentrically mounted in the housing for axial movement relative to the housing. Each of the plurality of piston/cylinder includes a first end and a second end.

The first end of a first stage is hermetically, yet movably, attached to the second end of the second stage. The second end of the first stage is hermetically, yet movably, attached to the first end of the housing. The first end of the third stage is hermitically sealed and provides a mechanical means to attach the first end to the elevator cab. The second end of the third stage is hermitically, yet movably, attached to the first end of the second stage. The pneumatic piston has at least one lateral chamber being filled with the compressed air that passes via a passage through the housing. The passage may be a valve or a connector.

FIG. 7 illustrates the sectional view of the pneumatic telescopic piston in accordance with an embodiment. The pneumatic telescopic piston may be configured to have a base width between four to six inches and a top cylinder having a width between two to three inches. In one embodiment of the subject matter disclosed herein the pneumatic piston/s used in the elevator assembly may be composed of hard anodized aluminum alloy. Furthermore, the pneumatic piston/s may use a high impact low friction metal pistons and rubber bearings. Alternatively, the pneumatic piston may be pre-lubricated for use with a dry air compressor. The dry air compressor may at least one hundred fifty pounds per square inch pressure.

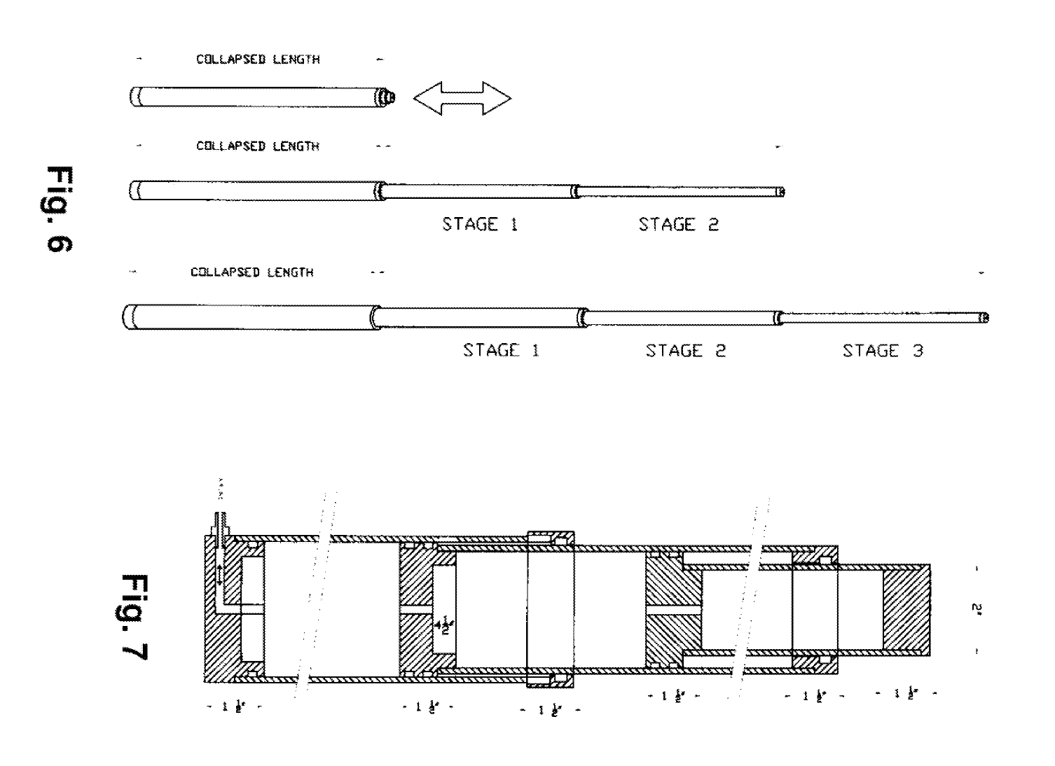

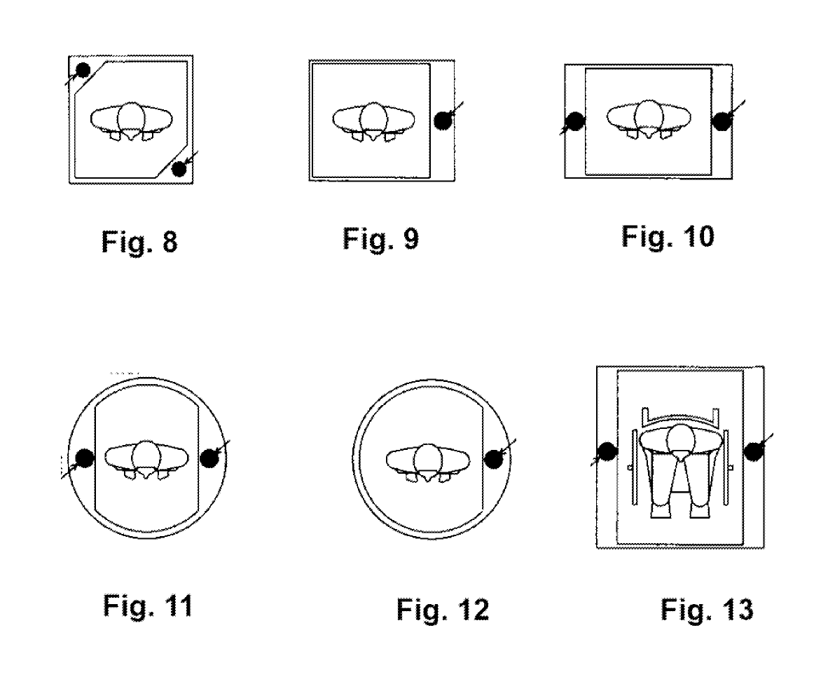

FIG. 8 illustrates an alternate embodiment of elevator cab and two pneumatic pistons in accordance with an embodiment. The two pistons are attached to the elevator cab at two corners of the cab. To accommodate the two pneumatic pistons, the top view of elevator cab is shaped like a hexagon. FIG. 9 illustrates an alternate embodiment of elevator cab and a single pneumatic piston in accordance with an embodiment. The pneumatic piston is placed on one side of the cube or cuboid elevator cab. In one embodiment, the elevator assembly may have at least one pneumatic piston capable of causing ascent by using only air pressure. In one embodiment, the elevator assembly may have at least one pneumatic piston capable of causing ascent by using only air pressure. The elevator assembly with pistons allows the assembly to do away with a pit, a hoistway, or a machine room. For example, the pneumatic may be piston placed between the longitudinal side of the elevator cab and the metal frame of the elevator housing. For example, the pneumatic piston is placed at the corner edges of the elevator car. FIG. 10 illustrates an alternate embodiment of elevator cab and two pneumatic pistons placed at two sides of the elevator cab in accordance with an embodiment. As shown in FIGS. 8-10, the elevator housing as well as the elevator cab both having a square or rectangular axial cross-section.

FIGS. 11-12 shows the elevator housing having a circular axial cross-section. The elevator cabs in FIGS. 11-12 have a combination of straight and circular edges to fit within respective housing. FIG. 11 illustrates an alternate embodiment of elevator cab and two pneumatic pistons in accordance with an embodiment. FIG. 12 illustrates an alternate embodiment of elevator cab and a single pneumatic piston in accordance with an embodiment. FIG. 13 illustrates an alternate embodiment of elevator cab and pneumatic piston enabled to carry disabled human being in accordance with an embodiment.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An elevator assembly for placing an elevator within a structure comprises:
an elevator housing having a metal frame to secure a movable elevator cab;
the elevator housing having a plurality of guides for directing the elevator cab within the housing; and
the elevator having at least one pneumatic pistons capable of causing ascent by air pressure, the pneumatic piston allowing elevator decent with gravity retraction;
the pneumatic piston placed between the longitudinal side of the elevator cab and the metal frame of the elevator housing.

2. The elevator assembly of claim 1, wherein the metal frame comprises at least one of steel or aluminum or a combination thereof or the like.

3. The elevator assembly of claim 1, wherein the housing comprises at least one of plastic, glass or wood panels or any combination thereof.

4. The elevator assembly of claim 1, wherein the plurality of guides for directing the elevator cab is one of a roller guide, a slide guide, or a rail guide or any combination thereof.

5. The elevator assembly of claim 1, wherein the assembly comprises four guides within the elevator frame.

6. The elevator assembly of claim 1, wherein the cab ceiling comprises perforations.

7. The elevator assembly of claim 1, wherein the metal frame is a self-supporting structure.

8. The elevator assembly of claim 1 further comprises a swing door allowing at least a 180 degree door opening angle.

9. The elevator assembly of claim 1 is configured to provide elevation of up to three floors.

10. The elevator assembly of claim 1 further comprises a plurality of light emitting diode (LED) lights and a plurality of fans, wherein the plurality of LED lights and the plurality of fans operation is configurable.

11. The elevator assembly of claim 1 further comprises a mechanical means to maintain the elevator car at a predefined elevation.

12. The elevator assembly of claim 1, wherein the pneumatic piston is a pneumatic telescopic piston assembly.

13. The elevator assembly of claim 1 further comprises electronic control module.

14. The elevator assembly of claim 12, wherein the pneumatic telescopic piston assembly comprising:
a housing with an internal chamber extending longitudinally thereof;
the housing having a plurality of inner cylinders there within, wherein the housing and the plurality of inner cylinders hermetically arranged in a telescopically coaxial relation;
each of the plurality of inner cylinders provide a stage respectively of telescope, wherein the length of the housing providing a collapsible length of the telescopic piston;
the housing being connected to a compressed air source; and
the housing and the plurality of inner cylinders having a plurality of valves enabling air to inflate or deflate the telescopic piston.

15. The elevator assembly of claim 14, wherein the pneumatic telescopic piston comprises up to three collapsible stages.

16. The elevator assembly of claim 14, wherein the pneumatic telescopic piston having a base width between four to six inches and a top cylinder having a width between two to three inches.

17. The elevator assembly of claim 1, wherein the pneumatic piston is composed of hard anodized aluminum alloy tube.

18. The elevator assembly of claim 1, wherein the pneumatic piston comprises a high impact low friction metal pistons and rubber bearings.

19. The elevator assembly of claim 1, wherein the pneumatic piston is pre-lubricated for use with a dry air compressor with at least one hundred fifty pounds per square inch.

20. A pneumatic telescopic piston assembly comprising:
a housing with an internal chamber extending longitudinally thereof;
the housing having a plurality of inner cylinders there within, wherein the housing and the plurality of inner cylinders hermetically arranged in a telescopically coaxial relation;
each of the plurality of inner cylinders provide a stage respectively of telescope, wherein the length of the housing providing a collapsible length of the telescopic piston;
the housing being connected to a compressed air source;
the housing and the plurality of inner cylinders having a plurality of valves enabling air to inflate or deflate the telescopic piston;
the pneumatic telescopic piston composed of hard anodized aluminum alloy;
the pneumatic telescopic piston having high impact low friction metal pistons and rubber bearings;
the pneumatic telescopic piston having up to three collapsible stages; and
the pneumatic telescopic piston having a base width between four to six inches and a top cylinder having a width between two to three inches.
